(19) United States
(12) Patent Application Publication
(10) Pub. No.: US 2022/0129704 A1
(43) Pub. Date: Apr. 28, 2022

(54) COMPUTING DEVICE

(71) Applicant: Hitachi Astemo, Ltd., Hitachinaka-shi, Ibaraki (JP)

(72) Inventor: Daichi MURATA, Tokyo (JP)

(73) Assignee: Hitachi Astemo, Ltd., Hitachinaka-shi, Ibaraki (JP)

(21) Appl. No.: 17/428,118

(22) PCT Filed: Oct. 21, 2019
(86) PCT No.: PCT/JP2019/041348

§ 371 Date: Aug. 3, 2021

(30) Foreign Application Priority Data
Mar. 8, 2019 (JP) 2019-042503

(51) Int. Cl. G06K 9/62; G06V 20/56; G06V 20/70

(52) U.S. Cl. CPC G06K 9/6257; G06V 20/56; G06K 9/6218; G06V 20/70; G06K 9/628

(57) ABSTRACT

A computing device includes: an inference circuit that calculates a recognition result of a recognition target and reliability of the recognition result using sensor data from a sensor group that detects the recognition target and a first classifier that classifies the recognition target; and a classification circuit that classifies the sensor data into either an associated target with which the recognition result is associated or a non-associated target with which the recognition result is not associated, based on the reliability of the recognition result calculated by the inference circuit.

### CROSS-REFERENCE TO RELATED APPLICATIONS

This application is based upon and claims the benefit of priority from Japanese Patent Application No. 2019-42503, filed on Mar. 8, 2019, the entire contents of which are incorporated herein by reference.

### TECHNICAL FIELD

The present invention relates to a computing device that computes data.

### BACKGROUND ART

There are multiple nerve cells called neurons in a brain of an organism. Each neuron acts to input a signal from other multiple neurons and output a signal to the other multiple neurons. An attempt to realize such a brain mechanism using a computer is a deep neural network (DNN), which is an engineering model that mimics the behavior of a nerve cell network of an organism.

An example of DNN is a convolutional neural network (CNN) that is effective for object recognition and behavior prediction. In recent years, development of a technology for realizing autonomous driving has been accelerated by mounting the CNN on an in-vehicle electronic control unit (ECU).

PTL 1 discloses a server system having a learning processing neural network that accumulates an unknown input signal as an additional learning input signal, and a client system having an execution processing neural network. The server system including the learning processing neural network performs basic learning of the learning processing neural network on basic learning data prepared in advance, and sends a coupling weighting factor thereof to each of the client systems including the execution processing neural network via a network. The client system sets the execution processing neural network and performs execution processing. When the unknown input signal determined as a false answer is detected, the client system sends the unknown input signal to the server system via a communication network, associates the unknown input signal with a teacher signal as additional learning data, performs additional learning of the learning processing neural network, and sets the obtained coupling weighting coefficient in the execution processing neural network of each of the client systems to perform the execution processing.

PTL 2 discloses a learning device that efficiently performs labeling by semi-supervised learning. This learning device includes: an input unit that inputs a plurality of labeled images and a plurality of unlabeled images; a CNN processing unit that generates a plurality of feature maps by performing CNN processing on the images; an evaluation value calculation unit that adds values, obtained by performing a process of adding entropy obtained for each pixel with respect to the plurality of feature maps generated by the CNN processing unit, further adding cross-entropy between a correct label given for each pixel and pixels of the plurality of feature maps with respect to the plurality of feature maps generated from the labeled images L, and subtracting the cross-entropy from the entropy, for the plurality of labeled images and the plurality of unlabeled images, to calculate an evaluation value; and a learning unit that learns a learning model to be used in the CNN processing so as to minimize the evaluation value.

PTL 3 discloses a neural network learning device that makes an output highly accurate in any state either before a change of an input state or after the change. The neural network learning device learns M coupling loads Wi (i=1 to M) based on an input learning model vector u related to a first state, newly adds N neurons Ni (i=a1 to aN) to a neural network for which learning has been completed, and learns the added N coupling loads Wi (i=a1 to aN). When performing this additional learning, the neural network learning device fixes the M coupling loads Wi (i=1 to M) for which learning has been completed, and learns the N coupling loads Wi (i=a1 to aN) based on at least the input learning model vector u related to a second state different from the first state.

### CITATION LIST

### Patent Literature

PTL 1: JP 2002-342739 A

PTL 2: JP 2018-97807 A

PTL 3: JP 2012-14617 A

### SUMMARY OF INVENTION

### Technical Problem

However, when the external environment recognition processing for autonomous driving is executed using the CNN, there is a problem that the recognition accuracy becomes unstable due to a difference in driving scenes (weather, a time zone, an area, an object to be recognized, and the like). Therefore, it is desirable to correct the CNN according to the driving scene each time using sensor data obtained from an in-vehicle sensor and correct data associated with the sensor data as a learning data set. In this case, it is necessary to manually associate correct data with approximately several thousands to several tens of thousands types of sensor data in order to correct the CNN. Therefore, it is difficult to generate the learning data set each time according to the driving scene from the viewpoint of human cost and work man-hours.

An object of the present invention is to improve the efficiency of generation of a learning data set.

### Solution to Problem

A computing device according to one aspect of the invention disclosed in the present application includes: an inference unit that calculates a recognition result of a recognition target and reliability of the recognition result using sensor data from a sensor group that detects the recognition target and a first classifier that classifies the recognition target; and a classification unit that classifies the sensor data into either an associated target with which the recognition result is associated or a non-associated target with which the recognition result is not associated, based on the reliability of the recognition result calculated by the inference unit.

### Advantageous Effects of Invention

According to a representative embodiment of the present invention, it is possible to improve the efficiency of generation of the learning data set. Other objects, configurations, and effects which have not been described above will become apparent from embodiments to be described hereinafter.

### BRIEF DESCRIPTION OF DRAWINGS

FIG. 1 is an explanatory view illustrating a generation example of a learning data set.

FIG. 2 is a block diagram illustrating a hardware configuration example of a learning system according to a first embodiment.

FIG. 3 is an explanatory view illustrating a structure example of a CNN.

FIG. 4 is an explanatory view illustrating an annotation example in a learning system.

FIG. 5 is a flowchart illustrating an example of a learning processing procedure by the learning system according to the first embodiment.

FIG. 6 is a block diagram illustrating a hardware configuration example of an in-vehicle device according to a second embodiment.

FIG. 7 is a flowchart illustrating an example of a learning processing procedure by the in-vehicle device according to the second embodiment.

FIG. 8 is a block diagram illustrating a hardware configuration example of an in-vehicle device according to a third embodiment.

FIG. 9 is a flowchart illustrating an example of a learning processing procedure by the in-vehicle device according to the third embodiment.

FIG. 10 is a block diagram illustrating a hardware configuration example of a learning system according to a fourth embodiment.

FIG. 11 is a flowchart illustrating an example of a learning processing procedure by the learning system according to the fourth embodiment.

### DESCRIPTION OF EMBODIMENTS

Hereinafter, a computing device according to each embodiment will be described with reference to the accompanying drawings. In the respective embodiments, the computing device will be described as, for example, an in-vehicle ECU mounted on an automobile. Note that “learning” and “training” are synonyms and can be replaced with each other in the following respective embodiments.

### First Embodiment

<Generation Example of Learning Data Set>

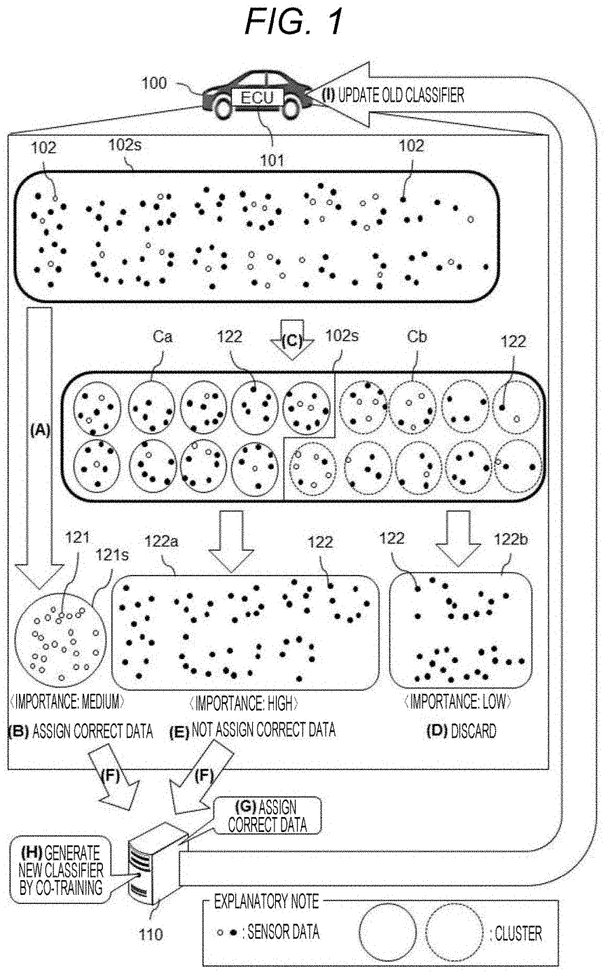

FIG. 1 is an explanatory diagram illustrating a generation example of a learning data set. The ECU 101 mounted on the automobile 100 acquires a sensor data group 102s by various sensors such as a camera, a LiDAR, and a radar. The sensor data group 102s is a set of pieces of sensor data detected with an external environment of the automobile 100 as a recognition target. Examples of the recognition target include a mountain, the sea, a river, and the sky, which are external environments, and objects (artificial objects, such as a person, an automobile, a building, and a road, and animals and plants such as a dog, a cat, and a forest) present in the external environments. Note that one automobile 100 is illustrated in FIG. 1 for convenience, but the following (A) to (F) are executed by a plurality of the automobiles 100 in practice.

(A) The ECU 101 of each of the automobiles 100 sequentially inputs sensor data 102 to a CNN to which a classifier (hereinafter, the classifier in the ECU 101 is referred to as an “old classifier” for convenience) is applied, and obtains a recognition result and a probability (hereinafter, an inference probability) regarding an inference of the recognition result from the CNN. The old classifier means the latest version of classifier currently in operation.

Since the CNN is used as an example in the first embodiment, the classifier means a learning model. For example, when using image data of an external environment captured by a camera as a recognition target, the recognition result is, for example, specific subject image data included in the image data, such as a person and an automobile, in addition to a background such as a mountain and the sky. The inference probability is an example of an index value indicating the reliability of the recognition result, and is a probability indicating the certainty of the recognition result.

When the inference probability exceeds a predetermined probability A, the sensor data 102 is classified as sensor data 121 (indicated by a white circle in FIG. 1) with importance “medium” among three levels of the importance, that is, “high”, “medium”, and “low”. The importance indicates a level of probability that erroneous recognition is likely to occur. The sensor data 121 has the inference probability exceeding the predetermined probability A, and thus, is the sensor data 102 that is unlikely to cause erroneous recognition.

(B) The ECU 101 of each of the automobiles 100 automatically assigns a recognition result as correct data to the sensor data 121 with the importance “medium”. A combination of the sensor data 121 and the recognition result is defined as a learning data set.

(C) The ECU 101 of each of the automobiles 100 performs dimension reduction of a feature vector of the sensor data 102 for each pieces of the sensor data 102 of the sensor data group 102s, and arranges the sensor data group 102s in a feature quantity space having dimensions corresponding to the number of feature quantities after the dimension reduction. Next, the ECU 101 executes clustering on the sensor data group 102s, and maps an inference probability to sensor data 122 (indicated by a black circle in FIG. 1) having the inference probability equal to or less than the predetermined probability A.

Then, the ECU 101 classifies a cluster group into a dense cluster Ca (indicated by a solid large circle in FIG. 1) in which the number of pieces of the sensor data 102 is equal to or more than a predetermined number B and a sparse cluster Cb (indicated by a dotted circle in FIG. 1) in which the number of pieces of the sensor data 102 is less than the predetermined number B. That is, since there are more pieces of the sensor data 122 with the predetermined probability A or less in which feature quantities are similar to each other in the denser cluster Ca, the sensor data 122 in the dense cluster Ca represents the feature quantity of a driving scene having a high appearance frequency.

In FIG. 1, B=6. As a point to be noted, even when there are B or more pieces of the sensor data 102 in a cluster, the cluster is the sparse cluster Cb unless there are B or more pieces of the sensor data 122 with the predetermined probability A or less.

(D) The ECU 101 of each of the automobiles 100 discards each pieces of the sensor data 122 of a sensor data group 122b, which is a set of pieces of the sensor data 122 in the sparse cluster Cb, as the sensor data 102 with the importance “low”. That is, the sparse cluster Cb has few pieces of the sensor data 122 with the predetermined probability A or less in which feature quantities are similar to each other. That is, the sensor data 122 in the sparse cluster Cb represents the feature quantity of a driving scene having a lower appearance frequency than a feature quantity of the sensor data 122 with the importance “high”. Therefore, the ECU 101 discards the sensor data group 122b with the importance “low”.

(E) The ECU 101 of each of the automobiles 100 selects the sensor data 122 in the dense cluster Ca as the sensor data 122 with the importance “high”. A set of pieces of the sensor data 122 with the importance “high” is defined as a sensor data group 122a. The ECU 101 does not assign correct data to each piece of the sensor data 122 of the sensor data group 122a. A reason thereof is that correct data is assigned by a CNN of a data center 110 having higher performance than human or the CNN of the ECU 101 because the inference probability of the CNN of the ECU 101 is equal to or less than the predetermined probability A.

(F) The ECU 101 of each of the automobiles 100 transmits, to the data center 110, a sensor data group 121s (learning data set group) in which a recognition result is assigned as correct data to each pieces of the sensor data 121 of (B) and the sensor data group 122a of (E). As a result, the data center 110 does not need to assign correct data to the sensor data group 121s.

(G) The data center 110 includes a high-performance large-scale CNN with a larger number of weights and hidden layers than human or the CNN of the ECU 101. The data center 110 assigns correct data to each piece of the sensor data 122 of the sensor data group 122a having the importance “high” by the large-scale CNN, thereby generating a learning data set.

(H) The data center 110 also has the same CNN as the CNN of the ECU 101. The data center 110 executes co-training using the CNN. Specifically, for example, the data center 110 mixes the learning data set, which is the sensor data group 121s with the correct data transmitted in (F), and the learning data set generated in (E) to assign the mixed learning data set to the CNN.

The data center 110 updates the weight of the CNN, that is, the old classifier by error back propagation according to a comparison result between the recognition result output from the CNN and the correct data assigned to the learning data set. The old classifier after the update is referred to as a new classifier. The data center 110 distributes the new classifier to the ECU 101 of each of the automobiles 100.

(I) The ECU 101 of each of the automobiles 100 updates the old classifier in the ECU 101 with the new classifier from the data center 110 to obtain the latest old classifier.

In this manner, the ECU 101 can reduce (narrow down) the number of pieces of sensor data, which need to be manually associated with correct data, to the number of pieces of the sensor data 122 in the sensor data group 122a with the importance “high”. In addition, the ECU 101 can automatically generate the learning data set for the sensor data of which the importance is “medium” without manual intervention. When using such a learning data set, it is possible to correct the CNN according to the driving scene in real time. Note that the present technology can be extended not only to deep learning but also to classifiers of classical machine learning such as support vector machine (SVM).

<Hardware Configuration Example of Learning System>

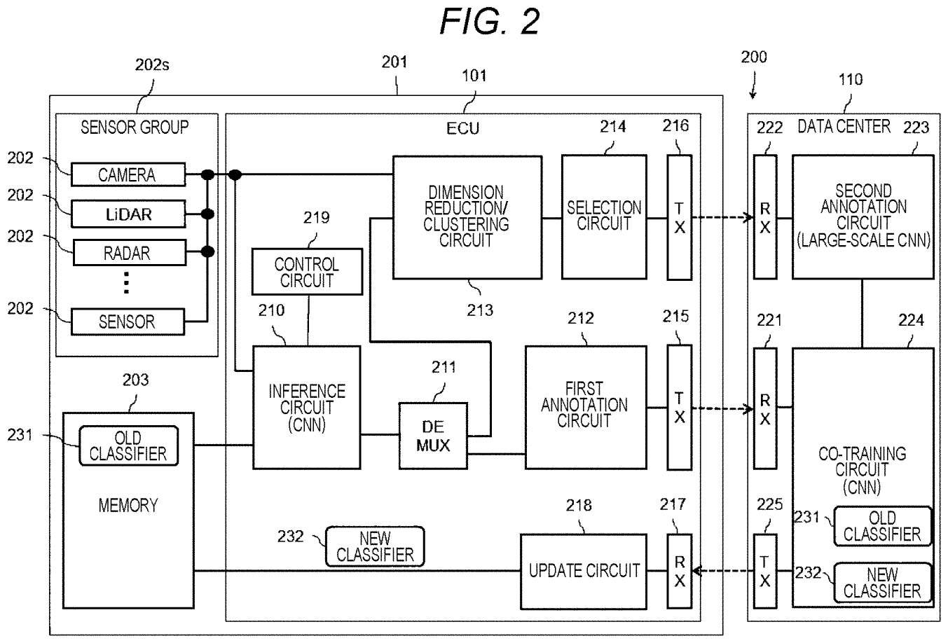

FIG. 2 is a block diagram illustrating a hardware configuration example of a learning system according to the first embodiment. A learning system 200 includes an in-vehicle device 201 and the data center 110. The in-vehicle device and the data center 110 are connected to be capable of communicating via a network such as the Internet. The in-vehicle device is mounted on an automobile. The in-vehicle device includes the above-described ECU 101, a sensor group 202s, and a memory 203.

The sensor group 202s includes a sensor 202 capable of detecting a driving situation of a mobile object such as the automobile 100. For example, the sensor group 202s is a set of the sensors 202 that can detect an external environment of the automobile as a recognition target, such as a camera, a LiDAR, and a radar. Examples of the camera include a monocular camera, a stereo camera, a far infrared camera, and an RGBD camera.

The LiDAR measures, for example, a distance to an object and detects a white line of mud. The radar is, for example, a millimeter wave radar, and measures a distance to an object. In addition, as an example of the sensor 202, a distance to an object may be measured by an ultrasonic sonar. In addition, the various sensors 202 may be combined to form a sensor fusion.

In addition, the sensor group 202s may include a positioning sensor that receives a GPS signal from a GPS satellite and identifies a current position of an automobile, a sunshine sensor that measures a sunshine time, a temperature sensor that measures a temperature, and a radio clock.

The memory 203 is a non-transitory and non-volatile recording medium that stores various programs and various types of data such as an old classifier.

The ECU 101 is a computing device including an inference circuit 210, a classification circuit 211, a dimension reduction/clustering circuit 213, a selection circuit 214, a first transmitter 215, a first annotation circuit 212, a second transmitter 216, a first receiver 217, an update circuit 218, and a control circuit 219. These are realized by, for example, an integrated circuit such as a field-programmable gate array (FPGA) and an application specific integrated circuit (ASIC).

The inference circuit 210 calculates a recognition result of a recognition target and an inference probability of the recognition result using sensor data from the sensor group 202s that detects the recognition target and an old classifier 231 that classifies the recognition target. The inference circuit 210 reads the old classifier 231 from the memory 203, and calculates the recognition result of the recognition target of the sensor group 202s and the inference probability of the recognition result when the sensor data from the sensor group 202s is input. The inference circuit 210 is, for example, a CNN.

In this manner, the use of the inference probability can make the classification circuit 211 classify the sensor data by a bootstrap method. In addition, not only the bootstrap method but also a graph-based algorithm, such as a semi-supervised k-nearest neighbor method graph and a semi-supervised mixed Gaussian distribution graph, may be applied to the inference circuit 210 as semi-supervised learning.

In the case of the graph-based algorithm, the inference circuit 210 calculates the similarity between the already generated learning data set, that is, the sensor data 121 with correct data, and the sensor data 102 newly input to the inference circuit 210, instead of the inference probability as an example of reliability. The similarity is an index value indicating closeness between both pieces of sensor data, specifically, closeness of a distance between both pieces of sensor data in a feature quantity space, for example.

Based on the inference probability of the recognition result calculated by the inference circuit 210, the classification circuit 211 classifies the sensor data 102 into either an associated target with which the recognition result is associated or a non-associated target with which the recognition result is not associated. The classification circuit 211 is a demultiplexer that classifies input data from an input source into any one of a plurality of output destinations and distributes the classified data to the corresponding output destination.

The input source of the classification circuit 211 is the inference circuit 210. The input data includes the sensor data 102 input to the inference circuit 210, the recognition result of the recognition target of the sensor group 202s from the inference circuit 210, and the inference probability thereof.

The plurality of output destinations are the first annotation circuit 212 and the dimension reduction/clustering circuit 213. The classification circuit 211 outputs the sensor data 121 with the inference probability exceeding the predetermined probability A and the recognition result of the recognition target of the sensor group 202s as associated targets to the first annotation circuit 212 (importance “medium”). In addition, the classification circuit 211 outputs the inference probability equal to or less than the predetermined probability A and an identifier uniquely identifying the sensor data 122 to the dimension reduction/clustering circuit 213 as non-associated targets.

In this manner, the use of the inference probability enables the first annotation circuit 212 to assign the recognition result of the recognition target of the sensor group 202s as correct data to the sensor data 121 with the inference probability exceeding the predetermined probability A by the bootstrap method. In addition, even when the graph-based algorithm is applied to the inference circuit 210, the first annotation circuit 212 can assign the recognition result of the recognition target of the sensor group 202s as correct data to the sensor data 121 with the inference probability exceeding the predetermined probability A.

The first annotation circuit 212 associates the sensor data 121 having the inference probability exceeding the predetermined probability A from the classification circuit 211 and the recognition result of the recognition target of the sensor group 202s, and outputs the resultant to the first transmitter 215 as a learning data set. Since the sensor data input from the classification circuit 211 to the first annotation circuit 212 is the sensor data 121 with the inference probability exceeding the predetermined probability A, the recognition result of the recognition target of the sensor group 202s has high reliability as the correct data.

Therefore, the first annotation circuit 212 associates the sensor data 121 having the inference probability exceeding the predetermined probability A from the classification circuit 211 directly with the recognition result of the recognition target of the sensor group 202s to obtain the learning data set. As a result, it is possible to improve the generation efficiency of the highly reliable learning data set.

The first transmitter 215 transmits the learning data set to the data center 110 at a predetermined timing, for example, during charging or refueling of each of the automobiles 100, or during stop such as during parking in a parking lot.

The dimension reduction/clustering circuit 213 sequentially receives inputs of the sensor data 102 from the sensor group 202s, and executes dimension reduction and clustering. Regarding the dimension reduction, it is possible to select whether to execute the dimension reduction by setting. The dimension reduction is a process of compressing a feature vector of the sensor data 102 into a feature vector having a smaller dimension.

Specifically, the dimension reduction/clustering circuit 213 performs linear conversion into a low-dimensional feature vector by extracting a feature quantity of sensor data using each method of multivariate analysis. For example, the dimension reduction/clustering circuit 213 calculates a contribution rate for each feature quantity of the sensor data 102 by principal component analysis, adds the contribution rates in descending order of the contribution rates, and leaves a feature quantity of the added contribution rate until exceeding a predetermined contribution rate, thereby obtaining a feature vector after the dimension reduction.

The dimension reduction/clustering circuit 213 clusters, as a clustering target, the input sensor data group 102s directly when dimension reduction is not executed, and the sensor data group 102s that has been subjected to dimension reduction when the dimension reduction is executed. Specifically, for example, the dimension reduction/clustering circuit 213 maps a feature vector of the sensor data 102 to a feature quantity space having dimensions corresponding to the number of feature quantities in the feature vector of the sensor data 102, and generates a plurality of clusters using, for example, a k-means method. The number of clusters k is set in advance. The dimension reduction/clustering circuit 213 outputs the plurality of clusters to the selection circuit 214.

The sensor data group 102s includes the sensor data 121 of which the inference probability exceeds the predetermined probability A and the sensor data 122 of which the inference probability is equal to or less than the predetermined probability A. Therefore, the feature quantity of the sensor data 121 is also considered for the cluster, and thus, the sensor data 121 and the sensor data 122 having a feature quantity close to the feature quantity of the sensor data 121 are included in the same cluster.

Note that the dimension reduction/clustering circuit 213 may determine the input sensor data 102 as the sensor data 122 with the inference probability equal to or less than the predetermined probability A and execute dimension reduction and clustering by regarding when receiving inputs of the non-associated targets (the inference probability equal to or less than the predetermined probability A and the recognition result of the recognition target of the sensor group 202s) from the classification circuit 211.

As a result, the dimension reduction or clustering of the sensor data 121 exceeding the predetermined probability A, which has been classified as the associated target, is not executed, and thus, the efficiency of calculation processing can be improved. Note that the sensor data 102 for which the non-associated target has not been input from the classification circuit 211 is classified as the associated target by the classification circuit 211, and thus, is overwritten by the subsequent sensor data 102 from the sensor group 202s.

In addition, the dimension reduction/clustering circuit 213 is not necessarily an integrated circuit that executes dimension reduction and clustering, and a dimension reduction circuit that executes dimension reduction and a clustering circuit that executes clustering may be separately mounted.

The selection circuit 214 selects a transmission target to the data center 110. Specifically, for example, the selection circuit 214 determines the density of each cluster from the dimension reduction/clustering circuit 213. Specifically, for example, the selection circuit 214 determines that a cluster is the dense cluster Ca when the number of pieces of sensor data 122 of which the inference probability in the cluster is equal to or less than the predetermined probability A is equal to or larger than a predetermined number B, and determines that a cluster is the sparse cluster Cb when the number of pieces of sensor data is smaller than the predetermined number B.

The sensor data 122 of which the inference probability in the dense cluster Ca is equal to or less than the predetermined probability A is sensor data with the importance “high”. The sensor data 122 of which the inference probability in the sparse cluster Cb is equal to or less than the predetermined probability A is the sensor data 122 with the importance “low”. The selection circuit 214 outputs the sensor data group 122a with the importance “high” to the second transmitter 216, and discards the sensor data group 122b with the importance “low”.

In addition, during the sparseness/denseness determination, the selection circuit 214 may determine that a cluster is the dense cluster Ca when the number of pieces of sensor data 122 of which the inference probability in the cluster is equal to or less than the predetermined probability A is relatively large among all clusters, and may determine that a cluster is the sparse cluster Cb when the number of pieces of sensor data is relatively small.

For example, when the total number of clusters is N (>1) and the number of clusters determined as the dense clusters Ca is M (<N), the selection circuit 214 may determine the top M clusters as the dense clusters Ca in descending order of the number of pieces of sensor data 122 of which the inference probability is equal to or less than the predetermined probability A, and determine the remaining clusters as the sparse clusters Cb.

The second transmitter 216 transmits the sensor data group 122a from the selection circuit 214 to the data center 110 at a predetermined timing, for example, during charging or refueling of each of the automobiles 100, or during stop such as during parking in a parking lot.

The first receiver receives a new classifier 232 distributed from the data center 110 and outputs the classifier 232 to the update circuit 218.

The update circuit 218 updates the old classifier 231 stored in the memory 203 with the new classifier 232 received by the first receiver 217. That is, the old classifier 231 is overwritten with the new classifier 232.

The control circuit 219 makes an action plan of the automobile 100 and controls the operation of the automobile 100 based on an inference result from the inference circuit 210. For example, when inference results, such as a distance to an object on the front side, what the object is, and what action the object takes, are given from the inference circuit 210, the control circuit 219 controls an accelerator or a brake of the automobile 100 so as to decelerate or stop according to the current speed and the distance to the object.

The data center 110 is a learning device including a second receiver 221, a third receiver 222, a second annotation circuit 223, a co-training circuit 224, and a third transmitter 225. The second receiver 221 receives a learning data set transmitted from the first transmitter 215 of the ECU 101 of each of the automobiles 100, and outputs the learning data set to the co-training circuit 224. The third receiver 222 receives the sensor data group 122a with which the recognition result is not associated transmitted from the second transmitter 216 of the ECU 101 of each of the automobiles 100, and outputs the sensor data group to the second annotation circuit 223.

The second annotation circuit 223 associates correct data with each piece of the sensor data 122 of the sensor data group 122a from the third receiver 222. Specifically, for example, the second annotation circuit 223 includes a large-scale CNN having a larger number of weights and a larger number of intermediate layers than the CNN of the inference circuit 210. A unique classifier capable of learning is applied to the large-scale CNN. When each piece of the sensor data 122 of the sensor data group 122a from the third receiver 222 is input, the large-scale CNN outputs a recognition result. The second annotation circuit 223 outputs the sensor data 122 and the output recognition result in association with each other to the co-training circuit 224 as the learning data set.

The second annotation circuit 223 may associate the sensor data 122 with the output recognition result unconditionally or conditionally. For example, as in the classification circuit 211 of the ECU 101, the sensor data 122 and the output recognition result are associated with each other as the learning data set only when an inference probability output from the large-scale CNN exceeds a predetermined probability. Note that the second annotation circuit 223 may perform relearning using the generated learning data set to update the unique classifier.

In addition, the second annotation circuit 223 may be an interface that outputs the sensor data 122 in a displayable manner and receives an input of correct data. In this case, a user of the data center 110 views the sensor data 122 and inputs appropriate correct data. As a result, the second annotation circuit 223 associates the sensor data 122 output in a displayable manner with the input correct data as a learning data set.

Note that, in this case, the second annotation circuit 223 outputs sensor data to a display device of the data center 110, and receives an input of correct data from an input device of the data center 110. In addition, the second annotation circuit 223 may transmit the sensor data 122 to a computer capable of communicating with the data center 110 in a displayable manner, and receive correct data from the computer.

The co-training circuit 224 relearns the old classifier 231 using the learning data set from the second receiver 221 and the learning data set from the second annotation circuit 223. Specifically, for example, the co-training circuit 224 is the same CNN as the inference circuit 210, and the old classifier 231 is applied. When a learning data set group obtained by mixing the learning data set from the second receiver 221 and the learning data set from the second annotation circuit 223 is input, the co-training circuit 224 outputs the new classifier 232 as a relearning result of the old classifier 231.

The third transmitter 225 distributes the new classifier 232 output from the co-training circuit 224 to each of the ECUs 101. As a result, each of the in-vehicle devices 201 can update the old classifier 231 with the new classifier 232.

<Structure Example of CNN>

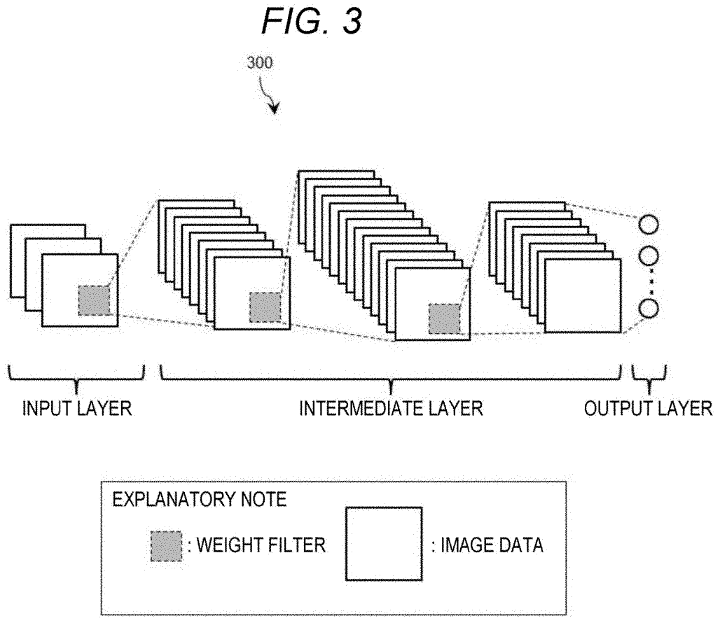

FIG. 3 is an explanatory view illustrating a structure example of a CNN. A CNN 300 is applied to, for example, the inference circuit 210, the co-training circuit 224, and the second annotation circuit 223 illustrated in FIG. 2. The CNN 300 forms n (three is an integer of one or more) convolutional operation layers each including an input layer, one or more (three layers as an example in FIG. 3) intermediate layers, and an output layer. In a convolutional operation layer on the i (i is an integer of two or more and n or less)th layer, a value output from the (i−1)th layer is set as an input, and a weight filter is convolved with the input value to output an obtained result to an input of the (i+1)th layer. At this time, high generalization performance can be obtained by setting (learning) a kernel coefficient (weight coefficient) of the weight filter to an appropriate value according to an application.

<Annotation Example>

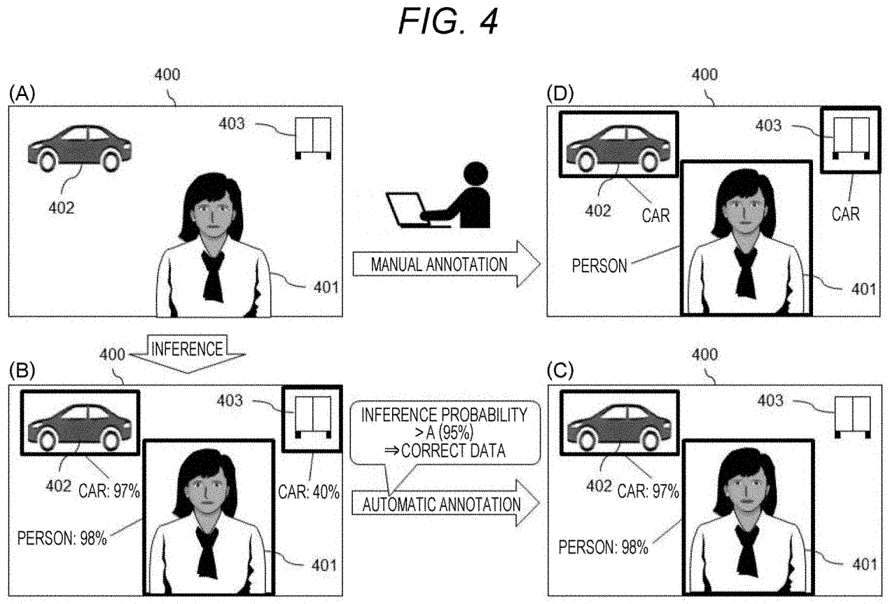

FIG. 4 is an explanatory view illustrating an annotation example in the learning system. (A) is input image data 400 to the ECU 101 captured by a camera. It is assumed that the input image data 400 includes image data 401 to 403.

(B) is the input image data 400 including an inference result and an inference probability in a case where the input image data 400 of (A) is given to the CNN 300 (the inference circuit 210 and the second annotation circuit 223). For example, it is assumed that an inference result is “person” and an inference probability is “98%” regarding the image data 401, an inference result is “car” and an inference probability is “97%” regarding the image data 402, and an inference result is “car” and an inference probability is “40%” regarding the image data 403.

(C) is an example of automatically assigning an annotation from the state of (B) (automatic annotation). The classification circuit 211 in the case of the ECU 101 or the second annotation circuit 223 in the case of the data center 110 determines that an inference result is correct and classifies each piece of the image data 401 to 403 as an association target (importance: medium) when an inference probability exceeds the predetermined probability A (for example, 95%), and determines that there is a possibility that the inference result is incorrect and classifies each piece of image data as a non-association target (importance: high) when the inference probability is equal to or less than the predetermined probability A. In the present example, the image data 401 and 402 are classified as association targets, and the image data 403 is classified as a non-association target.

(D) is an example in which “person” is assigned to the image data 401, “car” is assigned to the image data 402, and “car” is assigned to the image data 403 manually as correct data for the input image data 400 of (A) in the second annotation circuit 223 (manual annotation).

<Example of Learning Processing Procedure>

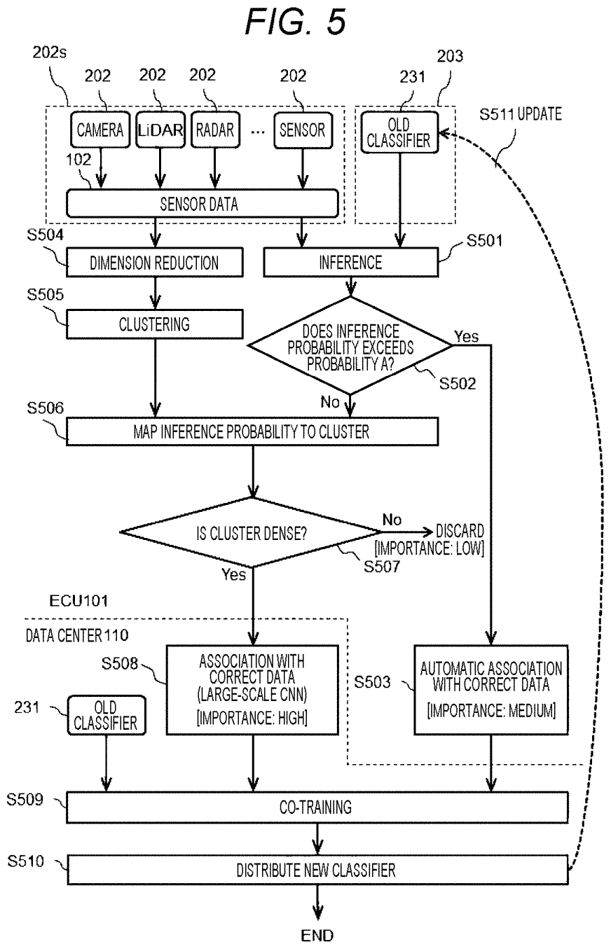

FIG. 5 is a flowchart illustrating an example of a learning processing procedure by the learning system according to the first embodiment. The inference circuit 210 reads the old classifier 231 from the memory 203, inputs the sensor data 102 from the sensor group 202s to the inference circuit 210, infers a recognition target, and outputs the sensor data, the recognition result, and an inference probability (Step S501).

The classification circuit 211 receives inputs of the sensor data 102, the recognition result, and the inference probability output from the inference circuit 210, and determines whether the inference probability exceeds the predetermined probability A (Step S502). When the inference probability exceeds the predetermined probability A (Step S502: Yes), the classification circuit 211 outputs the sensor data 121 of which the inference probability exceeds the predetermined probability A and the recognition result thereof to the first annotation circuit 212 as association targets. The first annotation circuit 212 associates the sensor data 121 of which the inference probability exceeds the predetermined probability A with the recognition result as a learning data set (Step S503), and transmits the learning data set from the first transmitter 215 to the data center 110.

In addition, when the inference probability is equal to or less than the predetermined probability A in Step S502 (Step S502: No), the classification circuit 211 outputs the inference probability equal to or less than the predetermined probability A and an identifier of the sensor data 122 to the dimension reduction/clustering circuit 213, and proceeds to Step S506.

In addition, the dimension reduction/clustering circuit 213 performs dimension reduction on feature vectors of the sensor data 102 sequentially input from the sensor group 202s (Step S504), maps the feature vectors after the dimension reduction on a feature space, and generates a plurality of clusters by clustering (Step S505).

Then, the dimension reduction/clustering circuit 213 identifies the sensor data 122 in a cluster based on the identifier of the sensor data 102 input from the classification circuit 211, and maps the inference probability equal to or less than the predetermined probability A input from the classification circuit 211 on the identified sensor data 102 (Step S506).

The selection circuit 214 performs sparseness/denseness determination for each cluster (Step S507). When determining that a cluster is sparse (Step S507: No), the selection circuit 214 discards the sparse cluster. When determining that a cluster as the dense cluster Ca (Step S507: Yes), the selection circuit 214 transmits the sensor data 122 of which the inference probability in the dense cluster Ca is equal to or less than the predetermined probability A to the data center 110, and proceeds to Step S508.

The data center 110 gives the sensor data 122 with the inference probability equal to or less than the predetermined probability A, transmitted from each ECU 101, to the large-scale CNN 300 and outputs an inference result, and associates the inference result as correct data with the sensor data 122 of which the input inference probability is equal to or less than the predetermined probability A to obtain a learning data set (Step S508).

The data center 110 reads the old classifier 231, mixes a sensor data group of the learning data set group transmitted in Step S503 and a sensor data group of the learning data set group generated in Step S508, and executes co-training (Step S509). Specifically, for example, the data center 110 inputs data to the CNN 300 to which the old classifier 231 is applied, and obtains an inference result for each piece of the sensor data 121 and 122. The data center 110 compares the inference result with the correct data associated with the sensor data 121 or 122, and executes error back propagation on the CNN 300 to relearn the old classifier 231 if there is inconsistency.

The data center 110 distributes the relearned old classifier 231 to each of the in-vehicle devices 201 as the new classifier 232 (Step S510). Each of the ECUs 101 updates the old classifier 231 with the new classifier 232 distributed from the data center 110 (Step S511).

In this manner, according to the first embodiment, the ECU 101 can reduce (narrow down) the number of pieces of sensor data 102, which need to be manually associated with correct data, to the number of pieces of the sensor data 122 in the sensor data group 122a with the importance “high”. In addition, the ECU 101 can automatically generate the learning data set for the sensor data 121 of which the importance is “medium” without manual intervention. Therefore, it is possible to improve the efficiency of generation of the learning data set.

### Second Embodiment

A second embodiment is Example 1 in which the in-vehicle device 201 alone generates a learning data set and updates the old classifier 231. The same content as that of the first embodiment will be denoted by the same reference sign, and the description thereof will be omitted.

<Hardware Configuration Example of In-Vehicle Device 201>

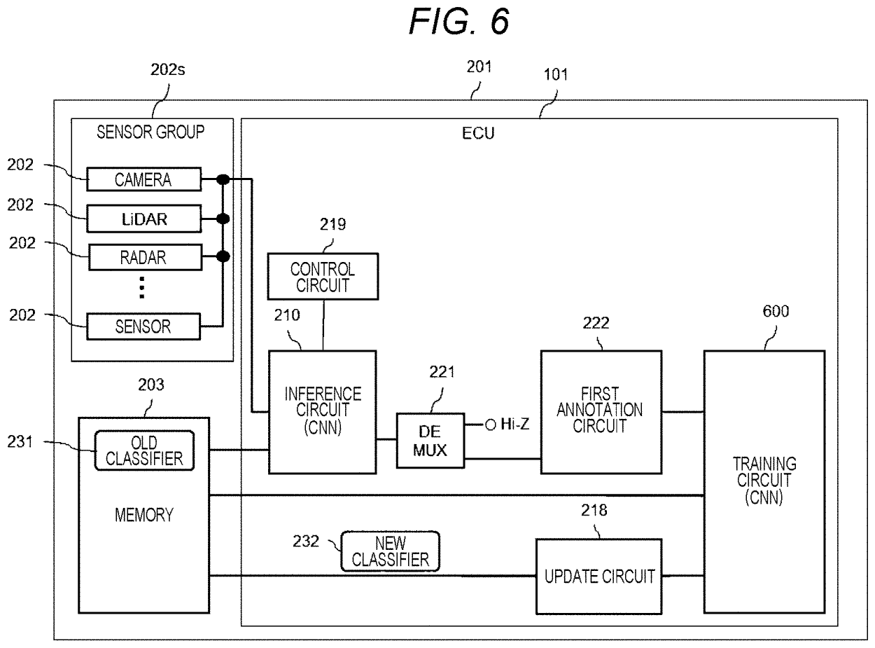

FIG. 6 is a block diagram illustrating a hardware configuration example of the in-vehicle device 201 according to the second embodiment. In the second embodiment, the ECU 101 does not include the dimension reduction/clustering circuit 213, the selection circuit 214, the first transmitter 215, the second transmitter 216, and the first receiver 217. Therefore, one output of the classification circuit 211 is connected to the first annotation circuit 212, but the other output is Hi-Z because there is no output destination.

In addition, in the second embodiment, the ECU 101 does not need to communicate with the data center 110, and thus, includes a training circuit 600 corresponding to the co-training circuit 224 of the data center 110. The training circuit 600 has the same configuration as the inference circuit 210. The training circuit 600 is connected to an output of the first annotation circuit 212. In addition, the training circuit 600 is connected so as to be capable of reading the old classifier 231 from the memory 203. In addition, the training circuit 600 is also connected to an input of the update circuit 218.

The training circuit 600 receives, from the first annotation circuit 212, an input of a learning data set in which the sensor data 121 of the inference probability exceeding the predetermined probability A is associated with a recognition result of a recognition target of the sensor group 202s. The training circuit 600 reads the old classifier 231 and performs training using the learning data set.

Specifically, for example, the training circuit 600 inputs the sensor data 121 of the learning data set to the CNN 300 to which the old classifier 231 is applied, and obtains an inference result for each pieces of the sensor data 121. The training circuit 600 compares the inference result with an inference result (correct data) associated with the sensor data 121, and executes error back propagation on the CNN 300 to relearn the old classifier 231 if there is inconsistency. The training circuit 600 outputs the new classifier 232, which is a relearning result, to the update circuit 218.

In the second embodiment, the update circuit 218 updates the old classifier 231 stored in the memory 203 with the new classifier 232 from the training circuit 600. That is, the old classifier 231 is overwritten with the new classifier 232.

<Example of Learning Processing Procedure>

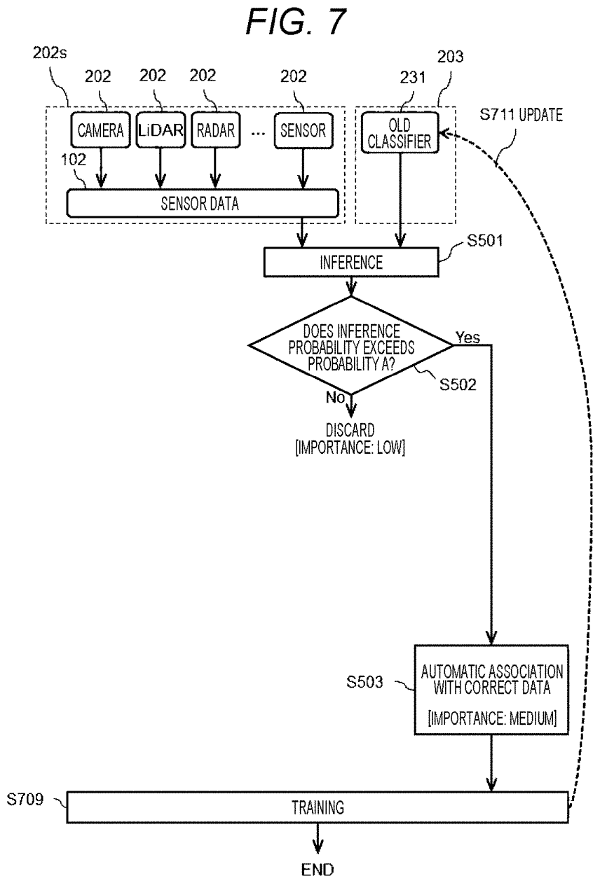

FIG. 7 is a flowchart illustrating an example of a learning processing procedure by the in-vehicle device 201 according to the second embodiment. In FIG. 7, Steps S504 to S511 of the first embodiment are not executed. When the inference probability is equal to or less than the predetermined probability A in Step S502 (Step S502: No), the classification circuit 211 discards the sensor data of which the inference probability is equal to or less than the predetermined probability A.

When the first annotation circuit 212 associates the sensor data 121 of which the inference probability exceeds the predetermined probability A with a recognition result as a learning data set (Step S503) and outputs the learning data set to the training circuit, the training circuit 600 relearns the old classifier 231 with the learning data set (Step S709). Then, the update circuit 218 that has acquired the new classifier 232 from the training circuit 600 updates the old classifier 231 stored in the memory 203 with the new classifier 232 (Step S711).

In this manner, the old classifier 231 can be relearned by the in-vehicle device 201 alone. Therefore, relearning of the old classifier 231 in the data center 110 is unnecessary, and operation cost of the data center 110 can be reduced. In addition, since the communication with the data center 110 is unnecessary, the in-vehicle device 201 can execute relearning of the old classifier 231 in real time. As a result, the in-vehicle device 201 can make an action plan of the automobile 100 and control an operation of the automobile 100 in real time.

In addition, since the communication with the data center 110 is unnecessary, the in-vehicle device 201 can execute relearning of the old classifier 231 even outside a communication range. As a result, the in-vehicle device 201 can make an action plan of the automobile 100 and control an operation of the automobile 100 outside the communication range.

### Third Embodiment

A third embodiment is Example 2 in which the in-vehicle device 201 alone generates a learning data set and updates the old classifier 231. The same content as those of the first embodiment and the second embodiment will be denoted by the same reference sign, and the description thereof will be omitted.

<Hardware Configuration Example of In-Vehicle Device 201>

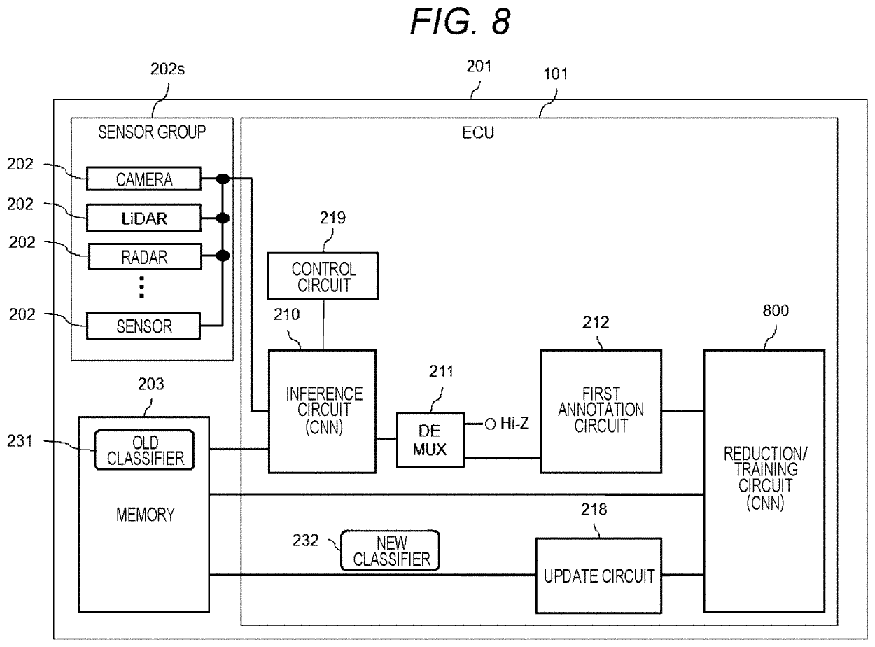

FIG. 8 is a block diagram illustrating a hardware configuration example of the in-vehicle device 201 according to the third embodiment. The third embodiment is an example in which a reduction/training circuit 800 is mounted on the ECU 101 instead of the training circuit 600 of the second embodiment. The reduction/training circuit 800 reduces the old classifier 231 prior to relearning and relearns the reduced old classifier 231 using a learning data set from the first annotation circuit 212.

Examples of the reduction include quantization of a weight parameter and a bias in the old classifier 231, pruning for deleting a weight parameter equal to or less than a threshold, low-rank approximation of a filter matrix by sparse matrix factorization for calculation amount reduction, and weight sharing for reducing connections of neurons in the CNN 300.

The reduction/training circuit 800 receives, from the first annotation circuit 212, an input of a learning data set in which the sensor data 121 of the inference probability exceeding the predetermined probability A is associated with a recognition result of a recognition target of the sensor group 202s. The reduction/training circuit 800 reads the old classifier 231 and reduces the old classifier 231. The reduction/training circuit 800 performs training using the learning data set with the reduced old classifier 231.

Specifically, for example, the reduction/training circuit 800 inputs the sensor data 121 of the learning data set to the CNN 300 to which the reduced old classifier 231 is applied, and obtains an inference result for each pieces of the sensor data 121. The reduction/training circuit 800 compares the obtained inference result with an inference result (correct data) associated with the sensor data 121, and executes error back propagation on the CNN 300 to relearn the old classifier 231 if there is inconsistency. The reduction/training circuit 800 outputs the new classifier 232, which is a relearning result, to the update circuit 218.

<Example of Learning Processing Procedure>

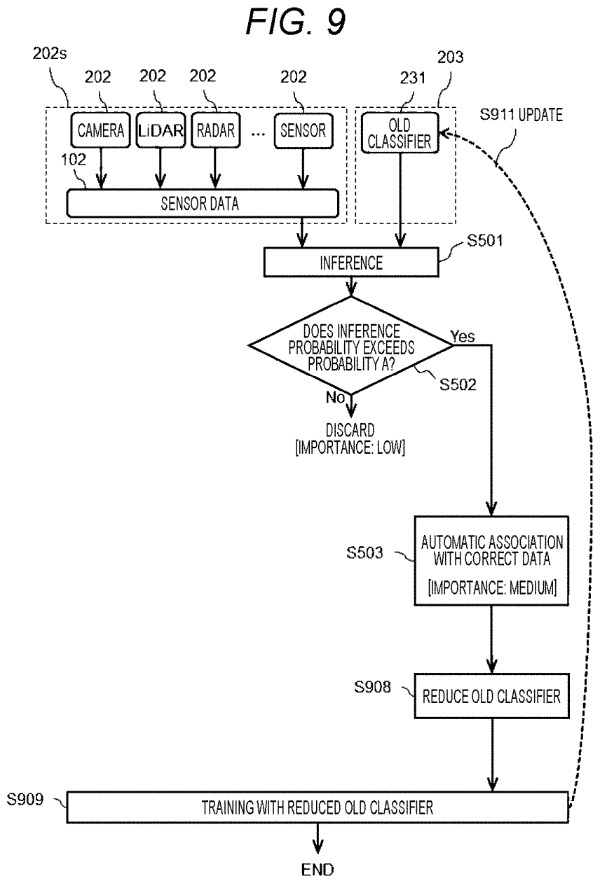

FIG. 9 is a flowchart illustrating an example of a learning processing procedure by the in-vehicle device 201 according to the third embodiment. In FIG. 9, Steps S504 to S511 of the first embodiment are not executed. When the inference probability is equal to or less than the predetermined probability A in Step S502 (Step S502: No), the classification circuit 211 discards the sensor data 122 of which the inference probability is equal to or less than the predetermined probability A.

When the first annotation circuit 212 associates the sensor data 121 of which the inference probability exceeds the predetermined probability A with a recognition result as a learning data set (Step S503) and outputs the learning data set to the reduction/training circuit 800, the reduction/training circuit 800 reads the old classifier 231 from the memory 203 and reduces the old classifier 231 (Step S908). Then, the reduction/training circuit 800 relearns the reduced old classifier 231 with the learning data set (Step S909). Then, the update circuit 218 that has acquired the new classifier 232 from the reduction/training circuit 800 updates the old classifier 231 stored in the memory 203 with the new classifier 232 (Step S911).

Since the old classifier 231 is reduced by the in-vehicle device 201 alone in this manner, it is possible to improve the efficiency of relearning of the old classifier 231. In addition, since the in-vehicle device 201 alone relearns the reduced old classifier 231, relearning of the old classifier 231 in the data center 110 becomes unnecessary, and operation cost of the data center 110 can be reduced.

In addition, since the communication with the data center 110 is unnecessary, the in-vehicle device 201 can execute relearning of the reduced old classifier 231 in real time. As a result, the in-vehicle device 201 can make an action plan of the automobile 100 and control an operation of the automobile 100 in real time.

In addition, since the communication with the data center 110 is unnecessary, the in-vehicle device 201 can execute relearning of the reduced old classifier 231 even outside a communication range. As a result, the in-vehicle device 201 can make an action plan of the automobile 100 and control an operation of the automobile 100 outside the communication range.

### Fourth Embodiment

A fourth embodiment is an example in which update of the old classifier 231 in the ECU 101 and update of the old classifier 231 in the data center 110 are selectively executed. The same content as that of the first embodiment will be denoted by the same reference sign, and the description thereof will be omitted.

<Hardware Configuration Example of Learning System>

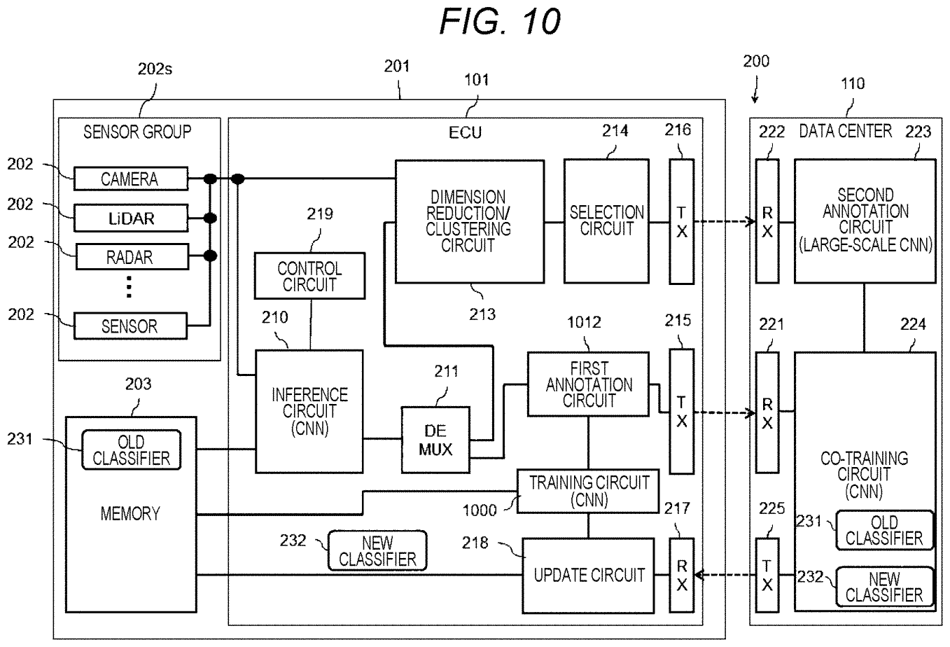

FIG. 10 is a block diagram illustrating a hardware configuration example of a learning system according to the fourth embodiment. The learning system 200 includes a first annotation circuit 1012, instead of the first annotation circuit 212, and a training circuit 1000 between the first annotation circuit 1012 and the update circuit 218. The first annotation circuit 1012 has the function of the first annotation circuit 212. The training circuit 1000 reads the old classifier 231 from the memory 203, and updates the old classifier 231 using a learning data set from the first annotation circuit 212.

In addition to the function of the first annotation circuit 212, the first annotation circuit 1012 has a determination function of determining whether to output the learning data set to the first transmitter 215 or the training circuit 1000. Specifically, for example, this determination function determines whether to output the learning data set to the first transmitter 215 or the training circuit 1000 based on, for example, the daily illuminance measured by a sunshine meter in the sensor group 202s, a current position of the ECU 101 measured by a GPS signal, the measured time, and the weather obtained from the Internet.

For example, when at least one of the daily illuminance, the weather, and a time zone is different from that at the time of the previous update of the old classifier 231, the first annotation circuit 1012 determines that an environmental change of a recognition target satisfies a minor update condition, and outputs the learning data set to the training circuit 1000. In this case, the output learning data set is considered to be approximate to a learning data set used at the time of the previous update of the old classifier 231. Therefore, the update of the old classifier 231 in the training circuit 1000 is minor.

On the other hand, for example, when a region including the current position at the time of the previous update of the old classifier 231 is different from a normal region, the first annotation circuit 1012 determines that the minor update condition is not satisfied, determines that an environmental change of a recognition target is not minor, and outputs the learning data set to the first transmitter 215. The normal region is, for example, a normal action range in a case where a user of the ECU 101 drives the automobile 100. For example, a commuting route using the automobile 100 is the normal action range, and a case of traveling to a resort outside the commuting route on holidays corresponds to the outside of the normal action range.

When the minor update condition is not satisfied, it is considered that the output learning data set is not approximate to a learning data set used at the time of the previous update of the old classifier 231. Therefore, the output learning data set is used for highly accurate update of the old classifier 231 in the co-training circuit 224.

Note that, in a case where at least one of the daily illuminance, the weather, and the time zone is different from that at the time of the previous update of the old classifier 231, and the region including the current position is different from that at the time of the previous update of the old classifier 231, the latter is preferentially applied. That is, the first annotation circuit 1012 determines that an environmental change of a recognition target is not minor by determining that the minor update condition is not satisfied, and outputs the learning data set to the first transmitter 215.

<Example of Learning Processing Procedure>

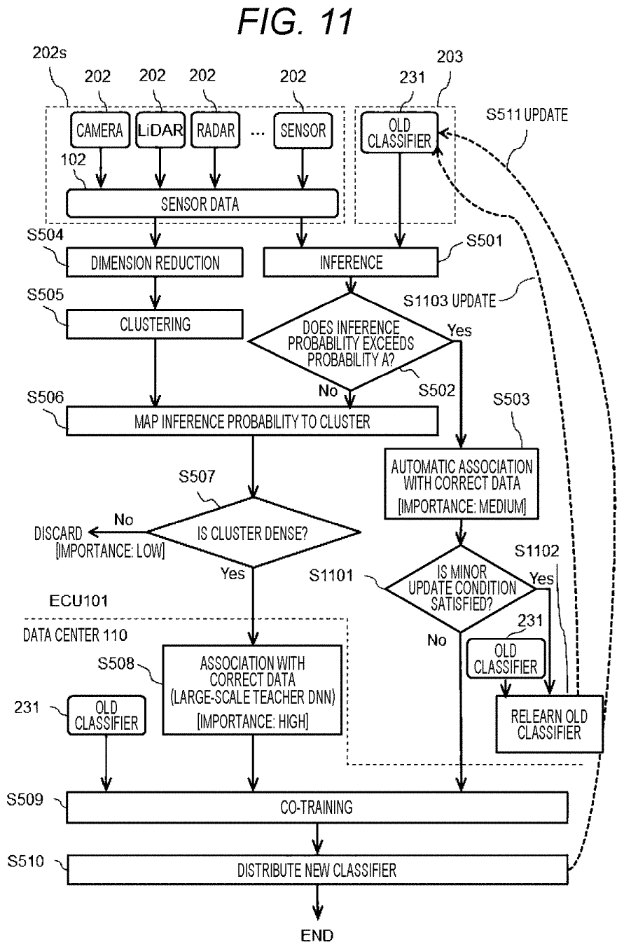

FIG. 11 is a flowchart illustrating an example of a learning processing procedure by the learning system according to the fourth embodiment. In the case of Step S502: Yes, the first annotation circuit 212 associates sensor data of which an inference probability exceeds the predetermined probability A with a recognition result as a learning data set (Step S503). Then, the first annotation circuit 1012 determines whether the minor update condition is satisfied (Step S1101). When the minor update condition is not satisfied (Step S1101: No), the ECU 101 transmits the learning data set from the first transmitter 215 to the data center 110.

On the other hand, when the minor update condition is satisfied (Step S1101: Yes), the training circuit 1000 outputs the learning data set to the training circuit 1000, and the training circuit 1000 relearns the old classifier 231 using the learning data set and outputs the new classifier 232 as a relearning result to the update circuit 218 (Step S1102). Then, the update circuit 218 updates the old classifier 231 stored in the memory 203 with the new classifier 232 (Step S1103).

In this manner, a relearning method can be selectively changed according to the environmental change of the recognition target according to the fifth embodiment. That is, in the case of a minor environmental change, a recognition result output from the inference circuit 210 can be optimized according to a change in a driving scene of the automobile 100 by updating the old classifier 231 using the update circuit 218. On the other hand, in the case of a significant environmental change, it is possible to improve the recognition accuracy in the inference circuit 210 to which the updated old classifier 231 is applied by updating the old classifier 231 in the data center 110.

Note that the functions of the ECU 101 of the first to fifth embodiments described above may be implemented by executing a program stored in the memory 203 by a processor in the ECU 101. Thus, each function of the ECU 101 can be executed by software.

1. A computing device comprising:
an inference unit that calculates a recognition result of a recognition target and reliability of the recognition result using sensor data from a sensor group that detects the recognition target and a first classifier that classifies the recognition target; and
a classification unit that classifies the sensor data into either an associated target with which the recognition result is associated or a non-associated target with which the recognition result is not associated, based on the reliability of the recognition result calculated by the inference unit.

2. The computing device according to claim 1, wherein
the sensor group includes a sensor capable of detecting a driving situation of a mobile object.

3. The computing device according to claim 1, wherein
the inference unit calculates the reliability of the recognition result based on a bootstrap method, a semi-supervised k-nearest neighbor method graph, or a semi-supervised mixed Gaussian distribution graph.

4. The computing device according to claim 1, wherein
the classification unit classifies the sensor data as the associated target when the reliability of the recognition result exceeds a predetermined threshold, and classifies the sensor data as the non-associated target when the reliability of the recognition result is equal to or less than the predetermined threshold.

5. The computing device according to claim 1, further comprising
an annotation unit that associates the recognition result with sensor data of the associated target when the sensor data is classified as the associated target by the classification unit.

6. The computing device according to claim 5, further comprising
a transmission unit that transmits the sensor data of the associated target associated with the recognition result to a learning device that learns a second classifier which classifies the recognition target using the sensor data of the associated target associated with the recognition result by the annotation unit.

7. The computing device according to claim 6, further comprising:
a reception unit that receives the second classifier from the learning device; and
an update unit that updates the first classifier with the second classifier received by the reception unit.

8. The computing device according to claim 1, further comprising:
a clustering unit that clusters the sensor data group based on a feature vector regarding each piece of sensor data of the sensor data group, which is a set of pieces of the sensor data;
a selection unit that selects a specific cluster in which a number of pieces of sensor data of the non-associated target with which the recognition result is not associated is equal to or larger than a predetermined number of pieces of data, or the number of pieces of sensor data of the non-associated target is relatively large, from a cluster group generated by the clustering unit; and
a transmission unit that transmits sensor data of the non-associated target in the specific cluster selected by the selection unit to a learning device that learns a second classifier which classifies the recognition target.

9. The computing device according to claim 8, further comprising
a dimension reduction unit that performs dimension reduction on a feature vector related to the sensor data,
wherein the clustering unit clusters sensor data after dimension reduction based on the feature vector after the dimension reduction.

10. The computing device according to claim 8, wherein
the selection unit discards another cluster other than the specific cluster.

11. The computing device according to claim 1, wherein
the classification unit discards the sensor data of the non-associated target when the sensor data is classified as the non-associated target.

12. The computing device according to claim 5, further comprising:
a training unit that learns a second classifier which classifies the recognition target using sensor data of the associated target associated with the recognition result; and
an update unit that updates the first classifier with the second classifier output from the training unit.

13. The computing device according to claim 5, further comprising:
a training unit that reduces a feature vector related to sensor data of the associated target associated with the recognition result and learns a second classifier which classifies the recognition target using sensor data after the reduction; and
an update unit that updates the first classifier with the second classifier output from the training unit.

14. The computing device according to claim 5, further comprising
a training unit that determines whether sensor data of the associated target associated with the recognition result satisfies a specific condition, and relearns the first classifier using the sensor data of the associated target associated with the recognition result when the specific condition is satisfied.
